(19) United States
(12) Patent Application Publication
(10) Pub. No.: US 2013/0210968 A1
(43) Pub. Date: Aug. 15, 2013

(54) Flame-Retardant Polyester Compounds

(71) Applicants: Sebastian Hoerold, Diedorf (DE); Wolfgang Wanzke, Augsburg (DE); Elke Schlosser, Augsburg (DE); Bernd Nass, Augsburg (DE)

(72) Inventors: Sebastian Hoerold, Diedorf (DE); Wolfgang Wanzke, Augsburg (DE); Elke Schlosser, Augsburg (DE); Bernd Nass, Augsburg (DE)

(73) Assignee: CLARIANT FINANCE (BVI) LIMITED, Tortola (VG)

(21) Appl. No.: 13/878,167

(22) PCT Filed: Oct. 25, 2011
(86) PCT No.: PCT/EP11/05364

§ 371 Date: Apr. 5, 2013

(30) Foreign Application Priority Data
Oct. 28, 2010 (DE) 10 2010 049 968.4

(51) Int. Cl. C08K 5/5399; C08K 5/3492

(52) U.S. Cl. CPC C08K 5/5399; C08K 5/34922; C08K 5/3492
USPC 524/89; 524/122; 524/116; 524/100; 524/101

(57) ABSTRACT

The invention relates to flame-retardant polyester compounds comprising as component A 40% to 89.9% by weight of thermoplastic polyesters, as component B 5% to 25% by weight of phosphinic salt of the formula (V) and/or diphosphinic salt of the formula (VI) and/or polymers thereof, in which R¹ and R² are H or C₁-C₆-alkyl and/or aryl; R³ is C₁-C₁₀-alkylene, C₆-C₁₀-arylene, -alkylarylene or -arylalkylene; M is Mg, Ca, Al, Sb, Sn, Ge, Ti, Fe, Zr, Ce, Bi, Sr, Mn, Li, Na, K and/or a protonated nitrogen base; m is 1 to 4; n is 1 to 4; and x is 1 to 4, and as component C 5% to 25% by weight of a phosphazene, as component D 0% to 15% by weight of reaction products of melamine with phosphoric acid and/or condensed phosphoric acids, as component E 0% to 45% by weight of reinforcing agents, and as component F 0.1% to 3% by weight of further additives, the sum of the components by weight being 100% by weight.

The invention relates to flame-retardant compounded polyester materials with improved fire properties and excellent mechanical properties.

The chemical composition of many plastics makes them readily combustible. Plastics therefore generally have to be modified with flame retardants in order to meet the stringent flame-retardancy requirements imposed by plastics processors and sometimes by legislation. A wide variety of flame retardants and flame retardant synergists is known for this purpose, and also available commercially.

For some time, preference has been given to use of non-halogenated flame retardant systems, because of their more advantageous ancillary properties in relation to smoke density and smoke composition in the event of a fire, and also for environmental reasons. Among the non-halogenated flame retardants, the salts of phosphinic acids (phosphinates) have proven to be particularly effective for thermoplastic polyesters (DE-A-2 252 258 and DE-A-2 447 727). Calcium phosphinates and aluminum phosphinates have been described as very effective in polyesters, and impair the properties of the polymer molding compositions less than, for example, the alkali metal salts (EP-A-0 699 708).

Furthermore, synergistic combinations of phosphinates with various nitrogen-containing compounds have been found which are more effective as flame retardants than the phosphinates alone in very many polymers (PCT/EP97/01664, DE-A-197 34 437, DE-A-197 37 727, and U.S. Pat. No. 6,255,371).

WO-A-2005/059 018 describes a polybutylene terephthalate with a nitrogen-containing flame retardant, a phosphinate, and an ash-forming polymer. Ash-forming polymers here are polyetherimides, polyphenylene ethers, polyphenylene sulfide, polysulfones, polyether sulfones, polyphenylene sulfide oxides, or phenolic resins. The flame retardancy is improved by the addition of the ash-forming polymer. Disadvantages are the high price of the ash-forming polymers, and also their tendency to cause discoloration.

DE-A-10 2005 050 956 describes thermoplastic molding compositions composed of a polybutylene terephthalate and of a polyester different from polybutylene terephthalate (PBT), and also phosphinates and a reaction product of a nitrogen-containing compound with phosphoric acid. Preference is given to combinations of polyethylene terephthalate (PET) and polytrimethylene terephthalate. Addition of PET is essential for obtaining UL 94 V-0, and also good tracking resistance and good mechanical properties. A GWIT of 775° C. is achieved in accordance with IEC 60695-2-13 at a thickness of 1.5 mm.

US-A-2009/0239986 describes flame-retardant thermoplastic polyester resins with 100 parts of polyester, from 1 to 60 parts of a cyclic oligomeric phosphazene compound, and from 1 to 50 parts of a melamine compound, and also from 1 to 20 parts of an inorganic metal compound, and from 0.1 to 5 parts of a fluorinated polyolefin. The melamine compound can be melamine, melamine cyanurate, or melamine phosphate, melamine pyrophosphate, or melamine polyphosphate. The inorganic compound can be inter alia magnesium hydroxide, zinc borate, zinc oxide, or titanium dioxide. Fire class UL 94 V-0 is achieved only in the presence of a fluorinated polyolefin. A disadvantage of this system is the poor flowability of the molding compositions.

JP-A-2010-037375 describes flame-retardant polyester resins with content of from 1 to 30% of phosphinate, from 0.01 to 3% of an acid scavenger, from 0.01 to 4% of a polyol component, from 0.1 to 10% of a vinyl resin component, and optionally additional flame retardants. Among the many additional flame retardants, phosphazenes are mentioned inter alia, but there are no indications of any particular effect of the phosphazenes. The only comparative example achieves only UL 94 V-2 and tracking resistance (CTI) of 450 V, in a PBT with glass fibers, with 4% of phosphinate and 1.9% of phosphazene. However, technical requirements nowadays placed on flame-retardant compounded polyester materials are UL 94 V-0 and CTI 600 V.

JP-A-2009-292897 describes flame-retardant polyesters composed of from 40 to 96.5 parts of polyalkylene terephthalates, from 3.5 to 50 parts of polystyrene resins, from 0 to 10 parts of compatibilizer, and also 100 parts of a flame retardant composed of from 10 to 60 parts of a phosphazene or phosphinate, from 20 to 70 parts of an aminotriazine nitrogen flame retardant, and from 0 to 20 parts of a metal borate, and a polyphenylene ether resin or polyphenylene sulfide resin, or phenolic resin. A disadvantage of the use of the polystyrene resin, of the compatibilizer, and also of the polyphenylene ether resins, or polyphenylene sulfide resins, or phenolic resins, is the insufficient color stability of additions of this type, and the color of the flame-retardant polyesters therefore shifts toward yellowish-brown. However, pure white color is a specific requirement placed upon compounded polyester materials.

EP-A-0945478 describes crosslinked phenoxyphosphazenes as flame retardants and flame-retardant polymer compositions with phosphazenes. It is preferable to use cyano-substituted phenoxyphosphazenes. Polymers are thermoplastic or thermoset resins, and inorganic fillers can be present, for example glass fibers or chalk. Other flame retardants described are halogen-free organophosphorus compounds, and mention is made of phosphates and phosphine oxides, but not of phosphinates. The thermoplastic resin can also be polyester, and other components mentioned are fluorinated resins and other flame retardants. Examples extend to PC/ABS, PPE/HIPS, and epoxy resins.

WO-A-2009/037859 describes flame-retardant polyamides with from 20 to 80% of polyamide, from 5 to 30% of a phosphinate compound, and from 0.01 to 10% of a phosphazene compound. Semiaromatic polyamides are involved, and the melting points are from 280 to 340° C. Fillers and reinforcing materials, and also other additives can likewise be used. No mention is made of polyesters.

DE-A-60011058 describes flame-retardant aromatic polyamides with 100 parts by weight of an aromatic polyamide resin, from 0.1 to 100 parts by weight of a crosslinked phosphazene compound, from 1 to 60 parts by weight of an inorganic, fibrous substance, and from 1 to 60 parts by weight of magnesium hydroxide.

JP-A-2007-138151 describes flame-retardant polyamides with phosphazenes. Phosphinates are mentioned as other flame retardants, and the examples combine phosphazene with melamine cyanurate and with a phenolic resin as ash-former in nylon-6,6. Without PTFE addition, V-0 is not achieved. However, phenolic resins cannot be used in polyesters, because of discoloration and polymer degradation. There are no indications of positive effects of a combination of phosphazene and phosphinate.

DE-A-69907251 describes flame-retardant resin compositions made of 100 parts by weight of a thermoplastic resin, from 0.001 to 50 parts by weight of a thermotropic liquid-crystalline polymer, and from 1 to 30 parts by weight of a halogen-free phosphazene compound. The thermoplastic resin can be a polyester. Disadvantages of the necessary addition of a liquid-crystalline polymer are the high price and the difficulty of processing molding compositions of this type.

When the phosphinates are used alone or in combination with other flame retardants in polyesters, there is generally a certain amount of polymer degradation, which has an adverse effect on the mechanical properties of the polymer system. Nor can flame-retardant polyesters with good mechanical properties be obtained with phosphazenes alone or in combination with other flame retardants. Other disadvantages are lack of certainty in UL 94 V-0 classifications due to excessive afterflame times of individual test specimens, lack of certainty in GWIT 775° C. classification at low wall thicknesses (<1.5 mm), and tensile strain at break values below 2%, in particular for glass (fiber) contents of from 25 to 35%.

Surprisingly, it has now been found that the combination of phosphinates with phosphazenes and optionally with other flame retardants, and also fillers and reinforcing materials, and further additives, can produce flame-retardant compounded polyester materials which feature certainty of UL 94 V-0 classification, increased glow-wire resistance, improved mechanical properties, good colorability, good flowability, and reduced polymer degradation.

The term phosphazenes means cyclic phosphazenes of the formula (I)

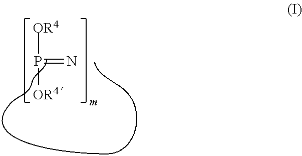

in which m is an integer from 3 to 25, and R⁴, and R^{4′} are identical or different and are Cᵢ-C₂₀-alkyl, C₆-C₃₀-aryl, C₆-C₃₀-arylalkyl, or C₆-C₃₀-alkyl-substituted aryl, or linear phosphazenes of the formula (II)

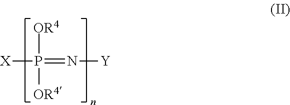

in which n is from 3 to 1000 and X is −N═P(OPh)₃ or —N═P(O)OPh, and Y is —P(OPh)₄ or —P(O)(OPh)₂.

EP-A-0 945 478 describes the production of phosphazenes of this type.

Particular preference is given to cyclic phenoxyphosphazenes of the formula P₃N₃C₃₆ (III)

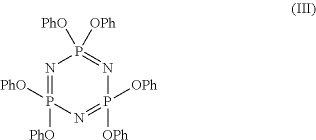 [SMILES: c1ccc(OP2(Oc3ccccc3)=NP(Oc3ccccc3)(Oc3ccccc3)=NP(Oc3ccccc3)(Oc3ccccc3)=N2)cc1]

or linear phenoxyphosphazenes of formula (IV).

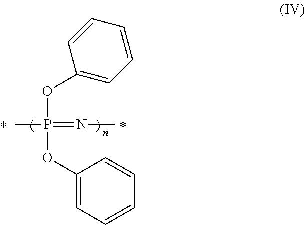

The phenyl moieties can optionally have substitution. Phosphazenes for the purposes of the present application are described in Mark, J. A., Allcock, H. R., West, R., “Inorganic Polymers”, Prentice Hall International, 1992, pages 61-141.

The invention therefore provides flame-retardant compounded polyester materials comprising, as component A, from 40 to 89.9% by weight of thermoplastic polyester, as component B, from 5 to 25% by weight of phosphinic salt of the formula (V) and/or diphosphinic salt of the formula (VI), and/or polymers of these

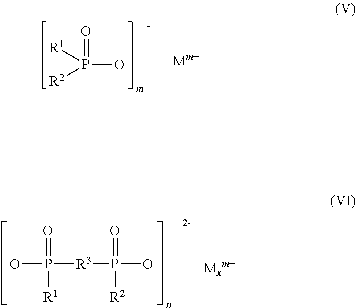

in which
R¹ and R² are identical or different and are H or C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, and/or a protonated nitrogen base;
m is from 1 to 4; n is from 1 to 4; x is from 1 to 4,
   and, as component C, from 5 to 25% by weight of a phosphazene of the formula (I) or (II)

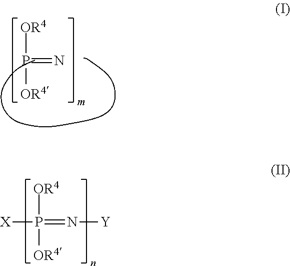

in which R⁴ and R^{4′} are identical or different and are C₁-C₂₀-alkyl, C₆-C₃₀-aryl, C₆-C₃₀-arylalkyl, or C₆-C₃₀-alkyl substituted aryl;
as component D, from 0 to 15% by weight of reaction products of melamine with phosphoric acid and/or with condensed phosphoric acids, or reaction products of condensates of melamine with phosphoric acid and/or with condensed phosphoric acids, and/or else a mixture of the products mentioned, and/or a nitrogen-containing flame retardant other than the abovementioned; as component E, from 0 to 45% by weight of reinforcing materials, and, as component F, from 0.1 to 3% by weight of further additives, where the entirety of the components gives 100% by weight.

It is particularly preferable that R¹ and R² are identical or different and are methyl, ethyl, n-propyl, isopropyl, n-butyl, tert-butyl, n-pentyl, and/or phenyl.

It is preferable that R³ is methylene, ethylene, n-propylene, isopropylene, n-butylene, tert-butylene, n-pentylene, n-octylene, or n-dodecylene; phenylene, or naphthylene; methylphenylene, ethylphenylene, tert-butylphenylene, methylnaphthylene, ethylnaphthylene, or tert-butylnaphthylene; phenylmethylene, phenylethylene, phenylpropylene or phenylbutylene.

Preference is given to flame-retardant compounded polyester materials comprising from 40 to 74.9% by weight of component A, from 5 to 25% by weight of component B, from 5 to 15% by weight of component C, from 0 to 10% by weight of component D, from 15 to 35% by weight of component E, and from 0.1 to 2% by weight of component F, where the entirety of the components gives 100% by weight.

Particular preference is given to flame-retardant compounded polyester materials comprising from 40 to 72.9% by weight of component A, from 5 to 20% by weight of component B, from 5 to 15% by weight of component C, from 2 to 10% by weight of component D, from 15 to 30% by weight of component E, and from 0.1 to 2% by weight of component F, where the entirety of the components gives 100% by weight.

It is preferable that component D involves melamine phosphate, dimelamine phosphate, melamine pyrophosphate, melamine polyphosphates, melam polyphosphates, melem polyphosphates, and/or melon polyphosphates.

It is preferable that component D involves melamine condensates, such as melam, melem, and/or melon.

It is preferable that component D involves oligomeric esters of tris(hydroxyethyl)isocyanurate with aromatic polycarboxylic acids, benzoguanamine, tris(hydroxyethyl)isocyanurate, allantoin, glycoluril, melamine, melamine cyanurate, dicyandiamide, and/or guanidine.

It is preferable that component D involves nitrogen compounds of the formulae (VII) to (XII), or a mixture thereof

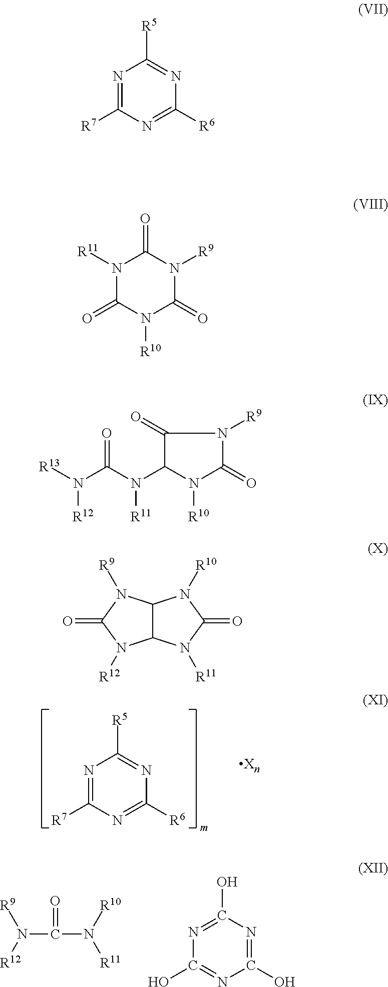

in which
R⁵ to R⁷ are hydrogen, C₁-C₈-alkyl, C₅-C₁₆-cycloalkyl, or -alkylcycloalkyl, optionally substituted with a hydroxy function or with a
C₁-C₄-hydroxyalkyl function, C₂-C₈-alkenyl, C₁-C₈-alkoxy, -acyl, -acyloxy, C₆-C₁₂-aryl or -arylalkyl, —OR⁸, and —N(R⁸)R⁹, including systems of N-alicyclic or N-aromatic type,
R⁸ is hydrogen, C₁-C₈-alkyl, C₅-C₁₆-cycloalkyl or -alkylcycloalkyl, optionally substituted with a hydroxy function or with a
C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are the same groups as R⁸ or else —O—R⁸,
m and n are mutually independently 1, 2, 3, or 4,
X are acids which can form adducts with triazine compounds (VII).

It is preferable that component E involves mineral particulate fillers based on talc, mica, silicate, quartz, titanium dioxide, wollastonite, kaolin, amorphous silicas, magnesium carbonate, chalk, feldspar, and/or barium sulfate, and/or glass fibers.

It is preferable that component F involves lubricants and/or mold-release agents.

It is preferable that the lubricants and/or mold-release agents involve long-chain fatty acids, their salts, their ester derivatives and/or amide derivatives, montan waxes, and/or low-molecular-weight polyethylene waxes and/or low-molecular-weight polypropylene waxes.

The invention also provides a process for producing the flame-retardant compounded polyester materials of the invention, which comprises mixing components A to F in the proportions by weight mentioned by extrusion in the melt.

The invention also provides fibers, foils, and moldings made of the flame-retardant compounded polyester materials as claimed in one or more of claims 1 to 12.

The invention provides the use of the fibers, foils, and moldings made of the flame-retardant compounded polyester materials of the invention in plugs, switches, capacitors, insulation systems, lamp sockets, coil formers, housings, control systems, and other articles.

Finally, the invention provides the use of the fibers, foils, and moldings made of the flame-retardant compounded polyester materials of the invention in the domestic sector, in industry, in medicine, in motor vehicles, in aircrafts, in ships, in spacecraft, and also in other means of conveyance, in office interiors, and also in other articles and buildings, where these require increased fire protection.

It is preferable that M is magnesium, calcium, aluminum, or zinc, particularly aluminum or zinc.

It is preferable that m is 2 or 3; that n is 1 or 3; and that x is 1 or 2.

The thermoplastic polyesters (component A) are selected from the group of the polyalkylene terephthalates. For the purposes of the invention, polyalkylene terephthalates are reaction products of aromatic dicarboxylic acids or of their reactive derivatives (e.g. dimethyl esters or anhydrides) and of aliphatic, cycloaliphatic, or araliphatic diols, and mixtures of said reaction products.

Polyalkylene terephthalates to be used with preference in the invention can be produced from terephthalic acid (or from its reactive derivatives) and from aliphatic or cycloaliphatic diols having from 2 to 10 carbon atoms, by known methods (Kunststoff-Handbuch [Plastics handbook], volume VIII, pp. 695-710, Karl-Hanser-Verlag, Munich,1973).

Polyalkylene terephthalates to be used with preference in the invention comprise at least 80 mol %, preferably 90 mol %, based on the dicarboxylic acid, of terephthalic acid moieties.

The polyalkylene terephthalates to be used with preference in the invention can comprise, alongside terephthalic acid moieties, up to 20 mol % of moieties of other aromatic dicarboxylic acids having from 8 to 14 carbon atoms, or moieties of aliphatic dicarboxylic acids having from 4 to 12 carbon atoms, for example moieties of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid.

The polyalkylene terephthalates to be used in the invention can be branched by incorporation of relatively small amounts of tri- or tetrahydric alcohols or tri- or tetrabasic carboxylic acids, these being as described by way of example in DE-A-19 00 270. Examples of preferred branching agents are trimesic acid, trimellitic acid, trimethylolethane and trimethylolpropane, and pentaerythritol.

Particular preference is given in the invention to polyalkylene terephthalates produced solely from terephthalic acid and from its reactive derivatives (e.g. its dialkyl esters) and ethylene glycol and/or 1,3-propanediol and/or 1,4-butanediol(polyethylene terephthalate, polytrimethylene terephthalate, and polybutylene terephthalate), and mixtures of said polyalkylene terephthalates.

Preferred polybutylene terephthalates comprise at least 80 mol %, preferably 90 mol %, based on the dicarboxylic acid, of terephthalic acid moieties and at least 80 mol %, preferably at least 90 mol %, based on the diol component, of 1,4-butanediol moieties.

The preferred polybutylene terephthalates can moreover comprise, alongside 1,4-butanediol moieties, up to 20 mol % of other aliphatic diols having from 2 to 12 carbon atoms, or of cycloaliphatic diols having from 6 to 21 carbon atoms, for example moieties of ethylene glycol, 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol, and -1,6,2-ethyl-1,3-hexanediol 2,2-diethyl-1,3-propanediol, 2,5-hexanediol, 1,4-di([beta]-hydroxyethoxy)benzene, 2,2-bis(4-hydroxycyclohexyl)propane, 2,4-dihydroxy-1,1,3,3-tetramethylcyclobutane, 2,2-bis(3-[beta]-hydroxyethoxyphenyl)propane, and 2,2-bis(4-hydroxypropoxyphenyl)propane (DE-A-24 07 674, DE-A-24 07 776, DE-A-27 15 932).

Other polyalkylene terephthalates to be used with preference in the invention are copolyesters which are produced from at least two of the abovementioned acid components and/or from at least two of the abovementioned alcohol components, and/or 1,4-butanediol. Particularly preferred copolyesters are poly(ethylene glyco1/1,4-butanediol)terephthalates.

The thermoplastic polyesters to be used as component A in the invention can also be used in a mixture with other polyesters and/or with other polymers.

Compounds that can be used as component C (phosphazenes) are preferably those described in Mark, J. A., Allcock, H. R., West, R., “Inorganic Polymers”, Prentice Hall International, 1992, pp. 61-141.

Preference is given to halogen-free phosphazenes. Preference is given to cyclic phosphazenes represented by the formula (I), in which m is an integer from 3 to 25, and R⁴ and R⁴′ are either identical or different

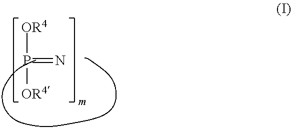

or straight-chain phosphazenes represented by the formula (II)

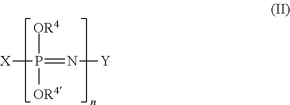

in which n is an integer from 3 to 1000, R⁴ and R^{4′} are likewise C₁-C₂₀-alkyl, C₆-C₃₀-aryl, C₆-C₃₀-arylalkyl, or C₆-C₃₀-alkyl substituted aryl, and X—N═P(OR⁴)₃ or —N═P(O)OR⁴, and Y—P(OR⁴)₄ or —P(O)(OR⁴)₂, or a crosslinked phosphazene, where at least one of the above phosphazenes (I) and (II) is crosslinked with at least one crosslinking group. The crosslinking group is composed of an o-phenylene group, of an m-phenylene group, of a p-phenylene group, of a biphenyl group, or of a group represented by the formula (XIII)

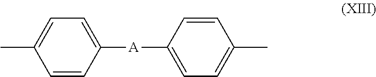

in which A is an —SO₂ group, an —S group, an —O group, or a —C(CH₃)₂ group, where the arrangement has each of said crosslinking groups between the two oxygen atoms which remain after removal of the R⁴ group, where the number of the R⁴ groups in the crosslinked phosphazene is from 50 to 99.9%, based on the total number of R⁴ groups in said phosphazene prior to crosslinking.

The above types of the halogen-free phosphazene can be used either alone or in combination.

Specific examples of the cyclic phosphazene and of the straight-chain phosphazene comprise a mixture of phosphazene compounds in which a phenoxy group and/or an alkoxy group has been introduced in a mixture of the cyclic and straight-chain chlorophosphazenes, e.g. hexachlorocyclotriphosphazenes, octachlorocyclotetraphosphazenes, and the like. The chlorophosphazenes are produced by reacting ammonium chloride and phosphorus pentachloride with one another at from 120 to 130° C.

Specific examples of the crosslinked phosphazene are phenoxyphosphazenes having a structure crosslinked through 4,4′-sulfonyldiphenylenes(bisphenol S moiety), the phenoxyphosphazene that has a structure crosslinked by a 2,2-(4,4′-diphenylene)isopropylidene group, and the phenoxyphosphazene that has a structure crosslinked by a 4,4′-diphenylene group, etc.

Examples of preferred phosphazenes are hexaphenoxycyclotriphosphazenes, octaphenoxycyclotetraphosphazenes, cyclopentaphosphazenes, and similar cyclophosphazenes where these have substitution by phenoxy groups, and also straight-chain phosphazenes, where these have substitution by phenoxy groups.

It is particularly preferable that component D involves melamine cyanurate.

The expression reaction products with phosphoric acid or with condensed phosphoric acids means compounds which are produced through reaction of melamine or of the condensed melamine compounds, such as melam, melem, or melon, etc., with phosphoric acid. Examples here are dimelamine phosphate, dimelamine pyrophosphate, melamine phosphate, melamine pyrophosphate, melamine polyphosphate, melam polyphosphate, melon polyphosphate, and melem polyphosphate, and mixed polysalts as are described by way of example in WO-A-98/39306.

It is particularly preferable that component D involves melamine polyphosphate.

It is particularly preferable in the invention to use mineral particulate fillers based on talc, wollastonite, kaolin, and/or glass fibers.

In particular for applications which require isotropy in dimensional stability and which require high thermal dimensional stability, examples being motor-vehicle applications for external bodywork parts, it is preferable to use mineral fillers, in particular talc, wollastonite, or kaolin.

It is particularly preferable that component E involves glass fibers.

Acicular mineral fillers can also moreover be used with particular preference as component E. In the invention, the expression acicular mineral fillers means a mineral filler with distinct acicular character. Acicular wollastonites may be mentioned as an example. It is preferable that the length:diameter ratio of the mineral is from 2:1 to 35:1, particularly from 3:1 to 19:1, most preferably from 4:1 to 12:1. The average particle size of the acicular minerals suitable in the invention is preferably smaller than 20 microns, particularly preferably smaller than 15 microns, with particular preference smaller than 10 microns.

The filler and/or reinforcing material can optionally have been surface-modified, for example with a coupling agent or coupling agent system, for example based on silane. However, the pretreatment is not absolutely essential. In particular when glass fibers are used, it is also possible to use, in addition to silanes, polymer dispersions, film-formers, branching agents, and/or glass-fiber-processing aids.

The glass fibers to be used with particular preference as component E in the invention, the fiber diameter of which is preferably from 7 to 18 microns, preferably from 9 to 15 microns, are added in the form of continuous-filament fibers or in the form of chopped or ground glass fibers. The fibers can have been modified with a suitable size system and with a coupling agent or coupling agent system, e.g. based on silane.

Preferred coupling agents are silane compounds from the group of aminopropyltrimethoxysilane, aminobutyltrimethoxysilane, aminopropyltriethoxysilane, aminobutyltriethoxysilane, and also the corresponding silanes which comprise a glycidyl group as substituent X.

Amounts of the silane compounds used for surface coating to modify the fillers are from 0.05 to 2% by weight, preferably from 0.25 to 1.5% by weight, and in particular from 0.5 to 1% by weight, based on the mineral filler.

The d₉₀ value or d₅₀ value of the particulate fillers in the molding composition or in the molding can be smaller than that of the fillers originally used as a result of the processing to give the molding composition or molding. The length distributions of the glass fibers in the molding composition or in the molding can be shorter than those originally used as a result of the processing to give the molding composition or the molding.

In another alternative preferred embodiment, the molding compositions can comprise, as component F, in addition to components A to E, at least one lubricant and mold-release agent. Examples of materials suitable for this purpose are long-chain fatty acids (e.g. stearic acid or behenic acid), salts thereof (e.g. Ca stearate or Zn stearate), and also the ester derivatives or amide derivatives thereof (e.g. ethylenebisstearylamide), montan waxes (mixtures composed of straight-chain, saturated carboxylic acids whose chain lengths are from 28 to 32 carbon atoms) and also low-molecular-weight polyethylene waxes and low-molecular-weight polypropylene waxes. It is preferable according to the invention to use lubricants and/or mold-release agents from the group of the low-molecular-weight polyethylene waxes, and also the esters of saturated or unsaturated aliphatic carboxylic acids having from 8 to 40 carbon atoms with saturated aliphatic alcohols having from 2 to 40 carbon atoms, and very particular preference is given here to pentaerythritol tetrastearate (PETS).

In another alternative preferred embodiment, the molding compositions can also comprise further additives, in addition to components A to E. Examples of conventional additives are stabilizers (e.g. UV stabilizers, heat stabilizers, gamma-ray stabilizers, hydrolysis stabilizers), antistatic agents, further flame retardants, emulsifiers, nucleating agents, plasticizers, processing aids, impact modifiers, dyes, and pigments. The additives can be used alone or in a mixture or in the form of masterbatches, or can be admixed in advance with component A in the melt, or applied to the surface thereof.

Examples of stabilizers that can be used are sterically hindered phenols and/or phosphites, hydroquinones, aromatic secondary amines, such as diphenylamines, substituted resorcinols, salicylates, benzotriazoles, and benzophenones, and also various substituted representatives of these groups, or a mixture of these. Suitable UV stabilizers that may be mentioned are various substituted resorcinols, salicylates, benzotriazoles, and benzophenones.

Impact modifiers (elastomer modifiers, modifiers) are very generally copolymers preferably composed of at least two of the following monomers: ethylene, propylene, butadiene, isobutene, isoprene, chloroprene, vinyl acetate, styrene, acrylonitrile, and acrylic or methacrylic esters having from 1 to 18 carbon atoms in the alcohol component.

Colorants which may be added are inorganic pigments, such as titanium dioxide, ultramarine blue, iron oxide, zinc sulfide, and carbon black, and also organic pigments, such as phthalocyanines, quinacridones, and perylenes, and also dyes, such as nigrosin, and anthraquinones, and also other colorants. For the purposes of the present invention, use of carbon black is preferred.

Examples of nucleating agents that can be used are sodium phenylphosphinate, calcium phenylphosphinate, aluminum oxide, or silicon dioxide, and also preferably talc.

Examples of processing aids that can be used are copolymers composed of at least one α-olefin with at least one methacrylic ester or acrylic ester of an aliphatic alcohol. Preference is given here to copolymers in which the α-olefin is composed of ethene and/or propene and the methacrylic ester or acrylic ester contains, as alcohol component, linear or branched alkyl groups having from 4 to 20 carbon atoms. Particular preference is given to butyl acrylate and 2-ethylhexyl acrylate.

Examples that may be mentioned of plasticizers are dioctyl phthalate, dibenzyl phthalate, butyl benzyl phthalate, hydrocarbon oils, and N-(n-butyl)benzene-sulfonamide.

It is preferable that the flame-retardant compounded polyester materials of the invention also comprise carbodiimides.

It is preferable that the flame-retardant compounded polyester materials comprise more than one thermoplastic polyester. It is particularly preferable that the flame-retardant compounded polyester materials comprise PBT and PET in blends.

It is preferable that the flame-retardant compounded polyester materials also comprise polycarbonates.

The term “phosphinic salt” hereinafter encompasses salts of phosphinic acid and of diphosphinic acid, and polymers thereof.

The phosphinic salts produced in an aqueous medium are in essence monomeric compounds. As a function of the reaction conditions, polymeric phosphinic salts can sometimes also be produced.

Examples of suitable phosphinic acids as constituent of the phosphinic salts are: dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methyiphenylphosphinic acid, and diphenylphosphinic acid.

The salts of the phosphinic acids according to the present invention can be prepared by known methods, described in some detail by way of example in EP-A-0 699 708.

The abovementioned phosphinic salts can be used in various physical forms for the inventive compounded polyester materials, as a function of the polymer used and of the properties desired. By way of example, the phosphinic salts can be milled to give a fine-particle form in order to achieve better dispersion in the polymer. It is also possible, if desired, to use a mixture of various phosphinic salts.

The phosphinic salts of the invention are thermally stable, and neither decompose the polymers during processing nor affect the preparation process for the plastics molding composition. The phosphinic salts are non-volatile under the usual conditions for preparation and processing of polyesters.

An example of the method for incorporating components B, C, and D into thermo-plastic polyesters premixes all of the constituents in the form of powder and/or pellets in a mixer and then homogenizes them in the polymer melt in a compounding assembly (e.g. a twin-screw extruder). The melt is usually drawn off in the form of a strand, cooled, and pelletized. It is also possible to introduce components C and D separately by way of a metering system directly into the compounding assembly.

It is likewise possible to admix the flame-retardant additives B, C, and D with finished polymer pellets or with finished polymer powder, and to process the mixture directly in an injection-molding machine to give molded parts.

It is also possible by way of example that, in polyesters, the flame-retardant additions B, C, and D are added to the polyester composition even before the polycondensation process is complete.

It is likewise possible to add components E and F at any of the abovementioned points.

The flame-retardant compounded polyester materials are suitable for producing moldings, films, filaments, and fibers, e.g. via injection molding, extrusion, or pressing.

### EXAMPLES

1. Components used
Commercially available polyesters (pellets), component A:
Polybutylene terephthalate (PBT): Ultradur® 4500 (BASF, D)

Component B:
Aluminum salt of diethylphosphinic acid, hereinafter termed DEPAL.
Zinc salt of diethylphosphinic acid, hereinafter termed DEPZN.

Component C:
SPB 100® phosphazene, Otsuka Chemical Co., Japan
Rabitle® FP 110 phosphazene, Fushimi Pharmaceuticals, Japan

Component D:
Melapur® MC (melamine cyanurate), Ciba Specialty Chemicals, CH
Melapur® 200/70 (melamine polyphosphate=MPP), Ciba Specialty Chemicals, CH
Delacal® M350 (melem), Delamin, UK

Component E:
Vetrotex® EC 10 P 952 (glass fibers), Vetrotex Reinforcement, D

Component F:
Lubricant: Licolub® FA1, montan wax, Clariant, CH
   2. Production, processing, and testing of flame-retardant compounded polyester materials

The flame retardant components were mixed in the ratio stated in the tables with the polymer pellets and optionally additives and incorporated at temperatures of from 240 to 280° C. in a twin-screw extruder (Leistritz ZSE 27 HP-44D). The homogenized polymer strand was drawn off, cooled in a water bath, and then pelletized.

After adequate drying, the molding compositions were processed at melt temperatures of from 260 to 280° C. in an injection-molding machine (Arburg 320C/KT), to give test specimens. The flame retardancy of the molding compositions was determined by the UL94V method (Underwriters Laboratories Inc. Standard of Safety, “Test for Flammability of Plastic Materials for Parts in Devices and Appliances”, page 14 to page 18, Northbrook 1998).
UL 94 provides the following fire classes:
V-0: no afterflame time longer than 10 sec, sum of afterflame times for 10 flame applications not greater than 50 sec, no burning drops, no complete combustion of the specimen, no afterglow time longer than 30 sec for the specimens after end of flame application
V-1: no afterflame time longer than 30 sec after end of flame application, sum of afterflame times for 10 flame applications not greater than 250 sec, no afterglow time longer than 60 sec for the specimens after end of flame application, remaining criteria as for V-0
V-2: ignition of cotton indicator due to burning drops, remaining criteria as for V-1 Not classifiable (ncl): does not comply with fire class V-2.

Glow-wire resistance was determined on the basis of the GWFI (Glow-Wire Flammability Index) test in accordance with IEC 60695-2-12, and also by the glow-wire ignition temperature (GWIT) test in accordance with IEC 60695-2-13. In the GWFI test, a glowing wire at temperatures of from 550 to 960° C. is used on 3 test specimens (for example plaques measuring 60×60×1.5 mm) to determine the maximum temperature at which an afterflame time of 30 seconds is not exceeded and no burning drops come from the specimen. In the GWIT test, a comparable test procedure is used and the glow-wire ignition temperature is stated, this being higher by 25K (30K at from 900° C. to 960° C.) than the maximum glow-wire temperature that does not lead to ignition, even during the time of exposure to the glowing wire, in 3 successive tests. Ignition is defined here as a flame with flame time >=5 sec.

TABLE 1
Comparative examples: PBT GF 30 with DEPAL, phosphazene,
and melamine polyphosphate in each case alone

| Example | | Comp. 1 | Comp. 2 | Comp. 3 |
|---|---|---|---|---|
| PBT | (% by wt.) | 49.7 | 49.7 | 49.7 |
| Glass fibers | (% by wt.) | 30 | 30 | 30 |
| DEPAL | (% by wt.) | 20 | | |
| SPB 100 phosphazene | (% by wt.) | | 20 | |
| Melamine polyphosphate | (% by wt.) | | | 20 |
| Lubricant | (% by wt.) | 0.3 | 0.3 | 0.3 |
| UL 94 (0.8 mm) | | V-0 | V-2 | V-2 |
| GWIT (0.75 mm) | (° C.) | 750 | 725 | 750 |
| Tensile strain at break | (% by wt.) | 1.9 | 2.6 | 2.0 |
| IR at RT | (kJ/m²) | 36 | 43 | 38 |
| NIR at RT | (kJ/m²) | 6.2 | 5.6 | 6.4 |

IR = impact resistance;
NIR = notched impact resistance

TABLE 2
Comparative examples: PBT GF 30 with DEPAL + MPP and,
respectively, phosphazene + MPP

| Example | | Comp. 4 | Comp. 5 | Comp. 6 |
|---|---|---|---|---|
| PBT | (% by wt.) | 49.7 | 49.7 | 49.7 |
| Glass fibers | (% by wt.) | 30 | 30 | 30 |
| DEPAL | (% by wt.) | 13.3 | | |
| SPB 100 phosphazene | (% by wt.) | | 13.3 | 10 |
| Melamine polyphosphate | (% by wt.) | 6.7 | 6.7 | 10 |
| Lubricant | (% by wt.) | 0.3 | 0.3 | 0.3 |
| UL 94 (0.8 mm) | | V-0 | V-2 | V-2 |
| GWIT (1 mm) | (° C.) | 750 | 750 | 750 |
| Tensile strain at break | (% by wt.) | 1.9 | 2.6 | 2.6 |
| IR at RT | (kJ/m²) | 37 | 43 | 41 |
| NIR at RT | (kJ/m²) | 6.2 | 6.4 | 7.0 |

TABLE 3
Combination of the invention: DEPAL with
phosphazene and melamine polyphosphate

| Example | | Inv. Ex. 1 | Inv. Ex. 2 | Inv. Ex. 3 |
|---|---|---|---|---|
| PBT | (% by wt.) | 49.7 | 49.7 | 49.7 |
| Glass fibers | (% by wt.) | 30 | 30 | 30 |
| DEPAL | (% by wt.) | 13.3 | 10 | 13.3 |
| SPB 100 phosphazene | (% by wt.) | 6.7 | 3.3 | 3.3 |
| Melamine polyphosphate | (% by wt.) | | 6.7 | 3.4 |
| Lubricant | (% by wt.) | 0.3 | 0.3 | 0.3 |
| UL 94 (0.8 mm) | | V-1 | V-0 | V-0 |
| GWIT (1 mm) | (° C.) | 750 | 775 | 775 |
| Tensile strain at break | (% by wt.) | 2.9 | 2.5 | 2.5 |
| IR at RT | (kJ/m²) | 42 | 39 | 41 |
| NIR at RT | (kJ/m²) | 7.0 | 6.8 | 6.7 |

TABLE 4
Combination of the invention: DEPAL with phosphazene and
melamine polyphosphate

| Example | | Inv. Ex. 4 | Inv. Ex. 5 | Inv. Ex. 6 |
|---|---|---|---|---|
| PBT | (% by wt.) | 49.7 | 49.7 | 49.7 |
| Glass fibers | (% by wt.) | 30 | 30 | 30 |
| DEPAL | (% by wt.) | 13.3 | 12 | |
| DEPZN | | | | 12 |
| Rabitle FP110 phosphazene | (% by wt.) | 3.3 | 5 | 5 |
| Melamine polyphosphate | (% by wt.) | 3.4 | 3 | 3 |
| Lubricant | (% by wt.) | 0.3 | 0.3 | 0.3 |
| UL 94 (0.8 mm) | | V-0 | V-0 | V-0 |
| GWIT (1 mm) | (° C.) | 750 | 775 | 775 |
| Tensile strain at break | (% by wt.) | 2.6 | 2.6 | 2.9 |
| IR at RT | (kJ/m²) | 42 | 41 | 43 |
| NIR at RT | (kJ/m²) | 7 | 7.4 | 7.4 |

TABLE 5
Combination of the invention: DEPAL with phosphazene and
melamine cyanurate, and, respectively, melem

| Example | | Inv. Ex. 7 | Inv. Ex. 8 | Inv. Ex. 9 |
|---|---|---|---|---|
| PBT | (% by wt.) | 49.7 | 49.7 | 49.7 |
| Glass fibers | (% by wt.) | 30 | 30 | 30 |
| DEPAL | (% by wt.) | 13.3 | 12 | 12 |
| Rabitle FP110 phosphazene | | 3.3 | 5 | 3 |
| Melem | (% by wt.) | | | 5 |
| Melamine cyanurate | (% by wt.) | 3.4 | 3 | |
| Lubricant | (% by wt.) | 0.3 | 0.3 | 0.3 |
| UL 94 (0.8 mm) | | V-0 | V-0 | V-0 |
| GWIT (1 mm) | (° C.) | 775 | 775 | 775 |
| Tensile strain at break | (% by wt.) | 2.4 | 2.5 | 2.6 |
| IR at RT | (kJ/m²) | 42 | 41 | 43 |
| NIR at RT | (kJ/m²) | 7 | 7.4 | 7.4 |

From comparative examples comp.1—comp. 6 it is apparent that sole use of DEPAL, phosphazene, or melamine polyphosphate, and the combination of

DEPAL with melamine polyphosphate, and also the combination of phosphazene with melamine polyphosphate cannot achieve simultaneously UL 94 V-0, GWIT 775° C., and tensile strain at break greater than 2%.

The combination of the invention: DEPAL or DEPZN with phosphazene and optionally with melamine polyphosphate, melamine cyanurate, or melem achieves tensile strain at break greater than 2%, certainty of UL 94 V-0 classification, and a GWIT of 775° C.

Other features of the flame-retardant compounded polyester materials of the invention are high whiteness (Yellowness Index <20 and L value greater than 95), good processability, and no exudation.

1. A flame-retardant compounded polyester material, comprising, as component A, from 40 to 89.9% by weight of thermoplastic polyester, as component B, from 5 to 25% by weight of phosphinic salt of the formula (V) a diphosphinic salt of the formula (VI), polymers of these or a mixture thereof 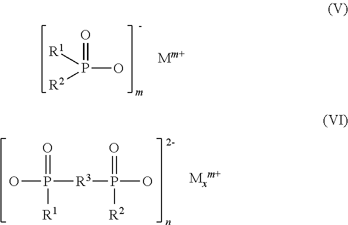
wherein
R¹ and R² are identical or different and are H or C₁-C₆-alkyl, linear or branched, aryl or a mixture thereof;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, a protonated nitrogen base or a mixture thereof;
m is from 1 to 4; n is from 1 to 4; x is from 1 to 4,
and, as component C, from 5 to 25% by weight of a phosphazene of the formula (I) or (II) 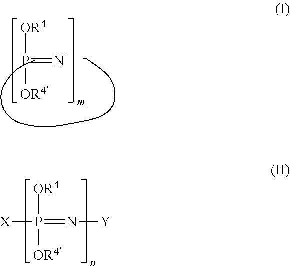
wherein R⁴ and R^{4′} are identical or different and are C₁-C₂₀-alkyl, C₆-C₃₀-aryl, C₆-C₃₀-arylalkyl, or C₆-C₃₀-alkyl substituted aryl;
as component D, from 0 to 15% by weight of reaction products of melamine with phosphoric acid or with condensed phosphoric acids, or reaction products of condensates of melamine with phosphoric acid, with condensed phosphoric acids, a nitrogen-containing flame retardant other than the abovementioned or a mixture thereof; as component E, from 0 to 45% by weight of reinforcing materials, and, as component F, from 0.1 to 3% by weight of further additives, where the entirety of the components gives 100% by weight.

2. The flame-retardant compounded polyester material as claimed in claim 1, wherein R¹ and R² are identical or different and are methyl, ethyl, n-propyl, isopropyl, n-butyl, tert-butyl, n-pentyl, phenyl or a mixture thereof.

3. The flame-retardant compounded polyester material as claimed in claim 1, wherein R³ is methylene, ethylene, n-propylene, isopropylene, n-butylene, tert-butylene, n-pentylene, n-octylene, or n-dodecylene; phenylene, or naphthylene; methylphenylene, ethylphenylene, tert-butylphenylene, methylnaphthylene, ethylnaphthylene, ec tert-butylnaphthylene; phenylmethylene, phenylethylene, phenylpropylene or phenylbutylene.

4. The flame-retardant compounded polyester material as claimed in claim 1, comprising from 40 to 74.9% by weight of component A, from 5 to 25% by weight of component B, from 5 to 15% by weight of component C, from 0 to 10% by weight of component D, from 15 to 35% by weight of component E, and from 0.1 to 2% by weight of component F, where the entirety of the components gives 100% by weight.

5. The flame-retardant compounded polyester material as claimed in claim 1, comprising from 40 to 72.9% by weight of component A, from 5 to 20% by weight of component B, from 5 to 15% by weight of component C, from 2 to 10% by weight of component D, from 15 to 30% by weight of component E, and from 0.1 to 2% by weight of component F, where the entirety of the components gives 100% by weight.

6. The flame-retardant compounded polyester material as claimed in claim 1, wherein the phospharenes comprise phenoxyphosphazenes.

7. The flame-retardant compounded polyester material as claimed in claim 1, wherein component D comprises melamine phosphate, dimelamine phosphate, melamine pyrophosphate, melamine polyphosphates, melam polyphosphates, melem polyphosphates, melon polyphosphates, melamine condensates or a mixture thereof.

8. The flame-retardant compounded polyester material as claimed in claim 1, wherein component D involves oligomeric esters of tris(hydroxyethyl)isocyanurate with aromatic polycarboxylic acids, benzoguanamine, tris(hydroxyethyl)isocyanurate, allantoin, glycoluril, melamine, melamine cyanurate, dicyandiamide, guanidine or a mixture thereof.

9. The flame-retardant compounded polyester material as claimed in claim 1, wherein component D comprises nitrogen compounds of the formulae (VII) to (XII), or a mixture thereof 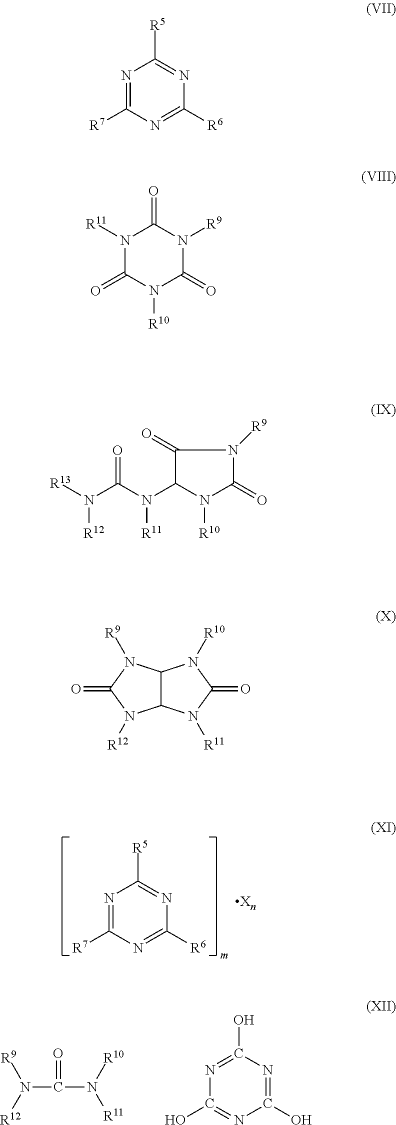
wherein
R⁵ to R⁷ are hydrogen, C₁-C₈-alkyl, C₅-C₁₆-cycloalkyl, or -alkylcycloalkyl, optionally substituted with a hydroxy function or with a C₁-C₄-hydroxyalkyl function, C₂-C₈-alkenyl, C₁-C₈-alkoxy, -acyl, -acyloxy, C₆-C₁₂-aryl or -arylalkyl, —OR⁸, and —N(R⁸)R⁹, including systems of N-alicyclic or N-aromatic type,
R⁸ is hydrogen, C₁-C₈-alkyl, C₅-C₁₆-cycloalkyl or -alkylcycloalkyl, optionally substituted with a hydroxy function or with a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are the same groups as R⁸ or else —O—R⁸,
m and n are mutually independently 1, 2, 3, or 4,
X are acids which can that form adducts with triazine compounds (VII).

10. The flame-retardant compounded polyester material as claimed in claim 1, wherein component E comprises mineral particulate fillers based on talc, mica, silicate, quartz, titanium dioxide, wollastonite, kaolin, amorphous silicas, magnesium carbonate, chalk, feldspar, barium sulfate, glass fibers or a mixture thereof.

11. The flame-retardant compounded polyester material as claimed in claim 1, wherein component F comprises lubricants, mold-release agents or a mixture thereof.

12. The flame-retardant compounded polyester material as claimed in claim 11, wherein the lubricants, mold-release agents or mixtures thereof comprise long-chain fatty acids, their salts, their ester derivatives, amide derivatives, montan waxes, low-molecular-weight polyethylene waxes, low-molecular-weight polypropylene waxes or a mixture thereof.

13. A process for producing a flame-retardant compounded polyester material comprising the step of mixing the flame-retardant compounded polyester by extrusion in the melt, wherein flame retardant compounded polyester comprises as component A, from 40 to 89.9% by weight of thermoplastic polyester, as component B, from 5 to 25% by weight of phosphinic salt of the formula (V), a diphosphinic salt of the formula (VI), polymers of these or a combination therefrom 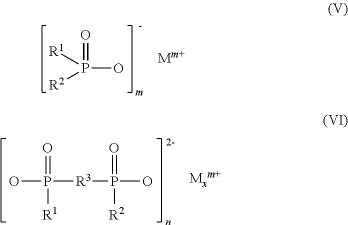
wherein
R¹ and R² are identical or different and are H or C₁-C₆-alkyl, linear or branched aryl or a mixture thereof;
R³ is C₁-C₁₀-alklene linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, a protonated nitrogen base or a mixture thereof;
m is from 1 to 4; n is from 1 to 4; x is from 1 to 4,
and, as component C, from 5 to 25% by weight of a phosphazene of the formula (I) or (II) 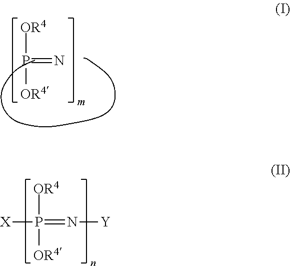
wherein R⁴ and R^{4′} are identical or different and are C₁-C₂₀-alkyl, C₆-C₃₀-aryl, C₆-C₃₀-arylalkyl, or C₆-C₃₀-alkyl substituted aryl;
as component D, from 0 to 15% by weight of reaction products of melamine with phosphoric acid or with condensed phosphoric acids, or reaction products of condensates of melamine with phosphoric acid, with condensed phosphoric acids, a nitrogen-containing flame retardant other than the abovementioned or a mixture thereof; as component E, from 0 to 45% by weight of reinforcing materials, and, as component F, from 0.1 to 3% by weight of further additives, where the entirety of the components gives 100% by weight.

14. A fiber, foil, molding, or molded part made of a flame-retardant compounded polyester material, wherein the flame retardant compounded polyester material comprises as component A, from 40 to 89.9% by weight of thermoplastic polyester, as component B, from 5 to 25% by weight of phosphinic salt of the formula (V), a diphosphinic salt of the formula (VI), polymers of these or a combination therefrom 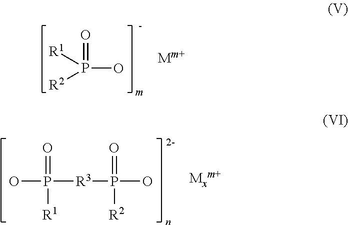
wherein
R¹ and R² are identical or different and are H or C₁-C₆-alkyl, linear or branched aryl or a mixture thereof;
R³ is C₁-C₁₀-alkylene linear or branched, C₆-C₁₀-arylene -alkylarylene or -arylalkylene;
M is Mg, Ca, Al, Sb, Sn, Ge, Ti, Fe, Zr, Ce, Bi, Sr, Mn, Li, Na, K, a protonated nitrogen base or a mixture thereof;
m is from 1 to 4; n is from 1 to 4; x is from 1 to 4,
and, as component C, from 5 to 25% by weight of a phosphazene of the formula (I) or (II) 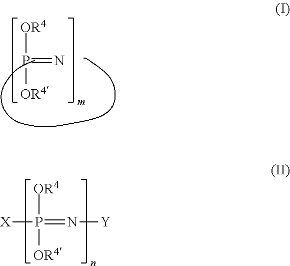
wherein R⁴ and R⁴′ are identical or different and are C₁-C₂₀-alkyl, C₆-C₃₀-aryl, C₆-C₃₀-arylalkyl, or C₆-C₃₀-alkyl substituted aryl;
as component D, from 0 to 15% by weight of reaction products of melamine with phosphoric acid or with condensed phosphoric acids, or reaction products of condensates of melamine with phosphoric acid, with condensed phosphoric acids, a nitrogen-containing flame retardant other than the abovementioned or a mixture thereof; as component E, from 0 to 45% by weight of reinforcing materials, and, as component F, from 0.1 to 3% by weight of further additives, where the entirety of the components gives 100% by weight.

15. A switch, insulation system, lamp socket, coil former, housing, control system having a fiber, foiling or molding wherein the fiber, foiling or molding comprises a flame-retardant compounded polyester, wherein the flame-retardant compounded polyester comprises, as component A, from 40 to 89.9% by weight of thermoplastic polyester, as component B, from 5 to 25% by weight of phosphinic salt of the formula (V), a diphosphinic salt of the formula (VI), polymers of these or a combination therefrom 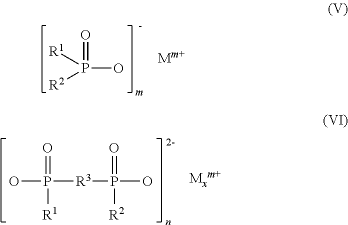
wherein
R¹ and R² are identical or different and are H or C₁-C₆-alkyl, linear or branched aryl or a mixture thereof;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, a protonated nitrogen base or a mixture thereof;
m is from 1 to 4; n is from 1 to 4; x is from 1 to 4, and, as component C, from 5 to 25% by weight of a phosphazene of the formula (I) or (II) 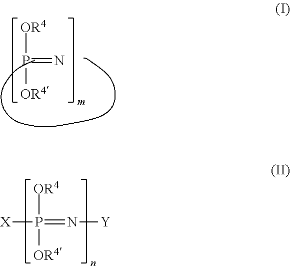
wherein R⁴ and R^{4′} are identical or different and are C₁-C₂₀-alkyl, C₆-C₃₀-aryl, C₆-C₃₀-arylalkyl, or C₆-C₃₀-alkyl substituted aryl;
as component D, from 0 to 15% by weight of reaction products of melamine with phosphoric acid or with condensed phosphoric acids, or reaction products of condensates of melamine with phosphoric acid, with condensed phosphoric acids, a nitrogen-containing flame retardant other than the abovementioned or a mixture thereof; as component E, from 0 to 45% by weight of reinforcing materials, and, as component F, from 0.1 to 3% by weight of further additives, where the entirety of the components gives 100% by weight.

16. A domestic article, industrial article, medicinal article, in motor vehicle, aircraft, ship, spacecraft, office interior wherein the motor vehicle, aircraft, ship, spacecraft, office interior comprises a fiber, foil, molding or molded part comprises a flame retardant compounded polyester, wherein the flame-retardant compounded polyester comprises, as component A, from 40 to 89.9% by weight of thermoplastic polyester, as component B, from 5 to 25% by weight of phosphinic salt of the formula (V), a diphosphinic salt of the formula (VI), polymers of these or a combination therefrom 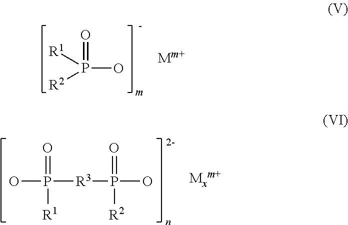
wherein
R¹ and R² are identical or different and are H or C₁-C₆-alkyl, linear or branched aryl or a mixture thereof;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, a protonated nitrogen base or a mixture thereof;
m is from 1 to 4; n is from 1 to 4; x is from 1 to 4,
and, as component C, from 5 to 25% by weight of a phosphazene of the formula (I) or (II) 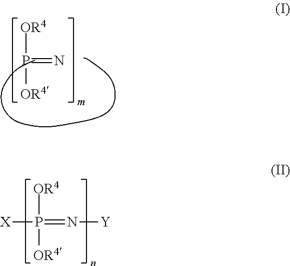
wherein R⁴ and R^{4′} are identical or different and are C₁-C₂₀-alkyl, C₆-C₃₀-aryl, C₆-C₃₀-arylalkyl, or C₆-C₃₀-alkyl substituted aryl;
as component D, from 0 to 15% by weight of reaction products of melamine with phosphoric acid or with condensed phosphoric acids, or reaction products of condensates of melamine with phosphoric acid, with condensed phosphoric acids, a nitrogen-containing flame retardant other than the abovementioned or a mixture thereof; as component E, from 0 to 45% by weight of reinforcing materials, and, as component F, from 0.1 to 3% by weight of further additives, where the entirety of the components gives 100% by weight.

17. The flame-retardant compounded polyester material as claimed in claim 7, wherein the melamine condensates are melam, melem, melon or a mixture thereof.
